(19) United States
(12) Patent Application Publication
(10) Pub. No.: US 2003/0092580 A1
(43) Pub. Date: May 15, 2003

(54) Invert emulsion drilling fluid and process

(75) Inventors: Rusty R. Mackey, Cochrane (CA); Larry W. Gatlin, Floresville, TX (US)

Correspondence Address: William L. Krayer, 1771 Helen Drive, Pittsburgh, PA, 15216, US

(73) Assignee: Clearwater, Inc.

(21) Appl. No.: 10/267,728

(22) Filed: Oct. 9, 2002

Related U.S. Application Data
(60) Provisional application No. 60/328,607, filed on Oct. 11, 2001.

(51) Int. Cl. C09K 7/00

(52) U.S. Cl. 507/100

(57) ABSTRACT

An invert emulsion, in which the aqueous phase includes a low concentration of potassium formate, is used in well drilling. The low concentration of potassium formate may be maintained by monitoring the potassium level in the circulating drilling fluid and/or by intermittently measuring the water activity of the drilling fluid. As an emulsifier, a reaction product of tall oil and a fatty alkanolamide may be used, optionally with an additional reaction product of tall oil with an aminoethylpiperazine.

### RELATED APPLICATION

This application claims the full benefit of Provisional Application 60/328,607 filed Oct. 11, 2001.

### TECHNICAL FIELD

For use in drilling wellbores for hydrocarbon recovery, an emulsifying system comprises certain tall oil reaction products. The emulsion is preferably prepared with an aqueous solution of 2% to 10% by weight of a potassium salt, preferably potassium formate, as the discontinuous phase; the continuous phase may be selected from a wide range of oils. As drilling proceeds, the potassium is monitored and an osmotic balance is maintained between the fluid and shale in the formation, preferably by replenishing the potassium formate as a function of the monitored water activity of the fluid.

### BACKGROUND OF THE INVENTION

Both oils and aqueous systems have been used in drilling wells and in treating subterranean hydrocarbon-containing formations. As an example of an oil-in-water system, the reader may be interested in reading Carney's U.S. Pat. No. 5,697,458. The present invention relates to an invert emulsion—that is, an emulsion wherein the continuous phase is an oil and the discontinuous phase is an aqueous solution of a potassium-containing salt, and its use in well drilling.

Invert emulsion drilling and well servicing fluids are described by Brandt and Scearce in U.S. Pat. No. 4,306,980. In addition to the continuous oil phase and the discontinuous water phase, they employed an emulsifier, an alkenyl succinic anhydride and lime, optionally with a brine-forming salt such as calcium chloride. Brandt et al review the patent literature of the time on invert emulsifiers, citing U.S. Pat. Nos., 2,861,042, 2,946,746, 3,259,572, 3,346,489, 3,590,005, and 3,654,177. The Brandt and Searce patent discusses the advantages of using an invert emulsion, particularly low fluid loss and the minimal exposure of the formation to water. Pomerleau et al, in U.S. Pat. No. 4,411,801, proposed an emulsifier comprising polyoxyethylene glycol 500 monotallate, nonyl phenol ethoxylates containing varying amounts of oxyethylene groups.

See also Lipowski et al in U.S. Pat. Nos. 4,505,828 and 4,552,670, Carnicom U.S. Pat. No. 4,436,636, and Mueller et al U.S. Pat. Nos. 5,318,954 5,318,956, 5,348,938 and 5,403,822.

In U.S. Pat. No. 6,194,361, Gatlin discloses a well lubricant composition which is a reaction product of tall oil with a fatty alkanolamide; preferably the reaction product is further combined with coconut oil diethanolamide.

### SUMMARY OF THE INVENTION

Our invention includes the use of an emulsion as a drilling fluid in drilling wells wherein the emulsion comprises (a) a discontinuous aqueous phase comprising water and 1% to 12% by weight of said aqueous phase of potassium formate and (b) a continuous phase comprising an oil, in a weight ratio of oil to aqueous phase of 95:5 to 75:25. Further, our invention includes a method of drilling a well in a subterranean formation comprising drilling the well with a drilling fluid comprising a water-in-oil emulsion wherein the water includes about 1% to about 12% potassium formate; the method may include regulating the concentration of potassium formate in the drilling fluid throughout the drilling to maintain the concentration of potassium formate in the water within the range of 1% to 12% by weight.

Our invention preferably employs as emulsifiers the lubricant compositions described in Gatlin U.S. Pat. No. 6,194,361 and accordingly the Gatlin U.S. Pat. No. 6,194,361 is incorporated herein in its entirety. The compositions are used as emulsifiers to create a water-in-oil emulsion wherein the discontinuous aqueous phase includes 1-12%, preferably 2% to 10%, potassium salt, preferably potassium formate, and the oil phase comprises any oil useful in well drilling and/or subterranean formation treatment. Such oils are well known and include Diesel oil, crude oil, distillate cuts of oil, seed oils and Canola oil.

The discontinuous aqueous phase comprises 5% to 25% by weight of the emulsion and the continuous oil phase comprises 75% to 95% by weight of the emulsion, disregarding the weight of the emulsifier and the weight of any organophilic clay that might be used. Depending on the conditions of use, the viscosity, and other properties desired, the practitioner may prefer, as examples, a 10% aqueous phase or a 20% aqueous phase. Therefore one preferred variation of our invention utilizes a weight ratio of oil phase to water phase in the range of 75:25 to 85:15 and another preferred variation utilizes a ratio of oil phase to water phase in the range of 85:15 to 95:5. In each case the preferred aqueous phase comprises 2% to 10% potassium formate.

A convenient way to make the emulsion is to (1) add the emulsifier to the oil while it is circulating in the wellbore; this will ensure a good mixing of the oil and emulsifier, (2) prepare an aqueous solution of the potassium salt, (3) add calcium oxide, preferably hot, to the circulating oil, then (4) add the potassium salt solution to the circulating oil and emulsifier. Optionally, a wetting agent may be added to the emulsion as it circulates.

Preferably, the emulsifier used in step 1 is a reaction product of a tall oil, preferably distilled, and a fatty alkanolamide. A preferred composition is the reaction product of a distilled high rosin tall oil (preferably 15-30% rosin) with diethanolamine and aminoethylpiperazine. It may be used in the form of a mixture of the reaction product and 40-60% carrier, optionally including inert salts, winterizing materials and the like, and it is used in an amount effective to make an emulsion, usually about 0.1% by volume. This may be referred to as the primary emulsifier. Optionally, a secondary emulsifier may be used. The secondary emulsifier comprises a modified alkanolamide made from tall oil. Wherever we use the term tall oil herein, it should be understood to include distilled and undistilled, and to include up to 50% rosin.

In particular, we may use as the primary emulsifier the composition described in Gatlin's U.S. Pat. No. 6,194,361 (incorporated herein in its entirety) for example in lines 55-67 of column 1:

. . . preferably formed by the sequential reaction and subsequent distillation of a tall oil fatty acid having a moderately low rosin content with a fatty alkanolamide, preferably in the presence of methyl ester of fatty alkanolamide, preferably in the presence of methyl ester of fatty acids, and most preferably when further reacted with an emulsifier such as coconut oil diethanolamide or an amide of aminoethylpiperazine u (AEP) under distillation conditions facilitating the removal of water and lighter reaction byproducts. The fatty acids and oils useful in the invention can range from C₈ to C₂₄, . . . ”

with fatty acids and oils having 12, 14, 16, 18, and 20 carbons being preferred. The use of methyl ester is preferred. The methods of making the reaction products recited in the Gatlin patent are applicable here and are adopted along with the entire specification of the Gatlin U.S. Pat. No. 6,194,361.

Alternatively, it may be said that our invention includes the use of a primary emulsifier made by reacting a tall oil, a fatty alkanolamide, and the reaction product of a tall oil with aminoethylpiperazine, and an optional secondary emulsifier which is a coconut oil diethanolamide or a derivative thereof.

Most preferably step (2) above will use potassium formate at a strength in the aqueous phase of about 5%; that is, 4-6%. Any potassium salt may be used, but we prefer potassium formate regardless of concentration within the range of 1-12% or, more preferably, 2-10%, specifically 3-8% and most preferably 4-6%. A desirable target is that the potassium formate will provide potassium ion in the aqueous phase at about 25,000 ppm to about 26,000 ppm.

For step (3), a typical amount of hot lime is 18 kg/m³ of the oil; the lime should be in excess of the amount necessary to react with the primary emulsifier.

Organophilic clays are compatible with our invention and may be used within the discretion of the operator skilled in the art.

Our emulsified drilling fluid provides excellent formation stability because it is able to carry the potassium to the interface with the formation in an economic manner while also providing the desired viscosity and other properties desirable for the removal of cuttings.

The process of using our novel drilling fluids may include adjusting the potassium content in the aqueous phase as a function of the potassium content as the drilling proceeds. The potassium content in the drilling fluid as it is used, i.e. as it circulates from the wellbore, is an indicator of the potassium adsorption by the shale and clay encountered by the drill bit, and accordingly the potassium content may be adjusted as the drilling progresses. This is done by either refraining from adding any more potassium, adding only a small amount or at a low rate, or adding potassium at a rate the same as or higher than a replacement rate. Likewise, potassium additions (or refraining from adding) may be modulated as a function of the osmotic balance between the shale or clay cuttings and the drilling fluid. Osmotic balance may be intermittently determined by a relative humidity meter. At the same time, emulsifier can be added or not as the drilling progresses according to the electrical stability of the emulsion—that is, to maintain a desired electrical stability of the emulsion.

Our invention has distinct advantages. Among the advantages of our invention is the fact that the drilling fluid, being low in water, substantially avoids the problem of damage to clay and shale caused by contact of an aqueous drilling fluid with the clay or shale in the formation. When the aqueous phase does contact the clay or shale, its potassium content minimizes the damage. Another distinct benefit of our invention is that it is not necessary to use bentonite or other oleophilic materials in the drilling fluid, which need not be called a mud. A third benefit of the invention is that the potassium content of the drilling fluid is quite low by conventional standards, and accordingly the chemical additive cost is minimized; moreover the entire composition exhibits superior environmental acceptance.

### DETAILED DESCRIPTION OF THE INVENTION

Field trials were made to investigate the potential parameters of the invention.

In one trial at Ansell, a reduced gel system was compared with the system of the invention using a distillate 822 as the oil phase. Total depths of the wells were in the range of 7800-8200 feet and the potassium in each case was 20,000 ppm. The potassium was regulated throughout by intermittently using a relative humidity meter to determine the osmotic balance, and adding potassium formate when necessary. Drilling days in the case of the invention were 10, while 27 days were required for the reduced gel system.

Table 1 shows the relevant data for another Ansell well. The emulsifier was a reaction product of tall oil and coconut oil diethanolamide.

TABLE 1
Maintenance of Potassium Level in Invert Emulsion-Ansell

| | | | Elec. | O/W | | |
|---|---|---|---|---|---|---|
| | Depth | % | stability | Ratio | K Ion | Water |
| Day | (m) | Solids | (v) | weight) | (mg/l) | Activity |
| 1 | 396 | — | 400 | 80/20 | 12000 | 0.87 |
| 2 | 849 | 4 | 380 | 83/17 | 8000 | 0.91 |
| 3 | 1278 | 6 | 450 | 83/17 | 6000 | 0.94 |
| 4 | 1358 | 7 | 475 | 82/18 | 18000 | 0.81 |
| 5 | 1574 | 5 | 490 | 82/18 | 22000 | 0.76 |
| 6 | 1756 | 6 | 470 | 85/15 | 19000 | 0.79 |
| 7 | 1883 | 5 | 500 | 85/15 | 26000 | 0.72 |
| 8 | 2079 | 8 | 1039 | 87/13 | 27000 | 0.71 |
| 10 | 2399 | 10 | 990 | 88/12 | 30000 | 0.68 |
| 11 | 2416 | 10 | 800 | 88/12 | 28000 | 0.70 |
| 12 | 2459 | 11 | 950 | 88/12 | 25000 | 0.73 |

Persons skilled in the art will recognize that the addition of potassium formate to the circulating drilling fluid between day 3 and day 4 resulted in a downward adjustment of water activity. The potassium formate concentration in the water phase of the invert emulsion ranged from about 1.3% to about 6.5%, which persons skilled in the are will also recognize as a very low range and a small absolute amount as the aqueous phase content ranges from 25% to 5% of the fluid; it was nevertheless effective in maintaining the stability of the formation.

The use of 20,000 ppm potassium was also compared to 100,000 ppm potassium in two different Ricinus wells using an invert emulsion of distillate 822, which required 22 and 37 drilling days respectively. Lower concentrations of potassium are therefore beneficial with the invert emulsion system of our invention.

In another comparison, five Medicine Lodge wells using the invention with 25,000 -26,000 ppm potassium maintained throughout the drilling had an average drilling time of 13.2 days, while four comparable wells using four different drilling fluid systems had an average drilling time of 22 days.

At one trial in Alberta, initially an invert emulsion was prepared using our preferred emulsifier having an oil/water ratio of 87/13, the discontinuous water phase containing 20,000 milligrams per liter of potassium ion, derived from potassium formate—that is, the water phase was prepared containing about 4.3% potassium formate. Table 2 shows the relevant data from a well using our invention, beginning with day 5.

TABLE 2
Maintenance of Potassium Ion Level in Invert
Emulsion-Medicine Lodge

| | Depth | Elec. | Vol % | | K Ion | Water |
|---|---|---|---|---|---|---|
| Day | (meters) | Stab. (v) | Solids | O/W | (mg/l) | Activity |
| 5 | 1125 | 400 | 8 | 87/13 | 20,000 | 0.77 |
| 8 | 1333 | 1200 | 9 | 89/11 | 25,000 | 0.73 |
| 9 | 1475 | 1250 | 6 | 90/10 | 22,000 | 0.74 |
| 10 | 1616 | 1250 | 6 | 91/9 | 27,000 | 0.71 |
| 11 | 1696 | 1350 | 6 | 92/8 | 28,000 | 0.70 |
| 13 | 1898 | 1300 | 6 | 89/11 | 28,000 | 0.70 |
| 14 | 1898 | 1250 | 6 | 89/11 | 27,000 | 0.71 |
| 15 | 2141 | 1150 | 6.5 | 89/11 | 20,000 | 0.74 |
| 16 | 2215 | 1212 | 6.5 | 89/11 | 24,000 | 0.62 |
| 17 | 2280 | 1149 | 6 | 87/13 | 21,000 | 0.65 |
| 19 | 2402 | 950 | 6 | 89/11 | 25,000 | 0.73 |
| 20 | 2450 | 900 | 7 | 89/11 | 26,000 | 0.71 |
| 21 | 2475 | 900 | 8 | 90/10 | 27,000 | 0.70 |
| 22 | 2481 | 900 | 8 | 90/10 | 26,000 | 0.71 |
| 24 | 2527 | 900 | 10 | 89/11 | 26,000 | 0.71 |
| 25 | 2575 | 800 | 11 | 90/10 | 28,000 | 0.67 |

Water activity was monitored by relative humidity measurements using a hygrometer. The fluid was placed in a sealed container having a stopper through which the hygrometer passed, terminating in the atmosphere above the liquid. After about fifteen minutes, during which the moisture level in the atmosphere above the fluid had become settled, it was recorded. The initial water activity of 0.77 was correlated to 20,000 mg/l of potassium ion, and potassium formate was added to the circulating drilling fluid intermittently to maintain the potassium ion in the range of 20,000 to 28,000, by observing and adjusting the water activity as indicated in Table 2. Persons skilled in the art will recognize that this is a low range of potassium formate, i.e between about 4.3% and about 6% by weight potassium formate in the discontinuous aqueous phase. In addition to monitoring the water activity, the electrical stability was also monitored to obtain a rough estimate of the stability of the emulsion.

It is clear from the above results that the invention saves considerable time in drilling.

Thus our invention includes an emulsion useful in drilling wells comprising (a) a discontinuous aqueous phase comprising water and 1% to 12% by weight of the aqueous phase of potassium formate and (b) a continuous phase comprising an oil, in a weight ratio of the oil to the aqueous phase of 95:5 to 75:25. It further includes a method of drilling a well in a subterranean formation comprising drilling the well with a drilling fluid comprising a water-in-oil emulsion wherein the water includes about 1% to about 12% potassium formate, and regulating the concentration of potassium formate in the drilling fluid throughout the drillling to maintain the concentration of potassium formate within the range of 1% to 12%. Preferably the invert emulsion is made using an emulsifier which is a reaction product of a tall oil, most preferably a distilled tall oil, and a fatty acid amide. The tall oil and/or tall oil amide may include rosins, preferably 1% to 50% rosins. The emulsifier may further include a coconut oil diethanolamide which may be added as a separate step.

As indicated above, the osmotic balance between the shale or clay in the subterranean formation and the circulating drilling fluid can be monitored with a relative humidity reader and this in turn is correlated to the potassium concentration; accordingly the potassium formate or other potassium salt can be maintained at the desired 1-12% level by intermittently monitoring the relative humidity, the osmotic balance, or the actual potassium content, and the potassium content regulated accordingly. Our invention therefore includes a method of drilling a well through a subterranean formation which contains shale or clay comprising drilling the well in the presence of an emulsion wherein the continuous phase comprises oil and the discontinuous phase comprises a 1% to 12% solution of a potassium salt, preferably potassium formate, the emulsion being circulated from the well to the surface and back to the well, intermittently monitoring the osmotic balance between the discontinuous phase and shale or clay cuttings circulating with the emulsion and maintaining the concentration of the potassium salt in said discontinuous phase within 1-12% by adding said potassium salt to maintain a desired osmotic balance thereof.

In other aspects, our invention includes a method of stabilizing an invert emulsion for use in drilling a borehole in or through a subterranean formation, said method comprising: preparing or obtaining an invert emulsion or an oil-based drilling fluid comprising an invert emulsion; determining the water activity of the formation; determining the water activity of the emulsion; adding sufficient formate or acetate to the drilling fluid such that the water activity of the emulsion is less than or about equal to the water activity of the formation; using the emulsion comprising the formate or acetate in drilling the borehole; monitoring the water activity of the formation and the water activity of the emulsion during the drilling; and adding additional formate or acetate to the emulsion as needed to maintain the water activity of the emulsion lower than or about equal to the water activity of the formation. The formate or acetate is preferably potassium formate. In another aspect, our invention comprises a method for drilling a borehole through a subterranean formation, the method comprising: preparing or obtaining an oil-based fluid; determining the water activity of the drilling fluid and the water activity of the formation; adding sufficient formate or acetate to the drilling fluid such that the water activity of the drilling fluid is less than or equal to the water activity of the formation; using the drilling fluid comprising the formate or acetate in drilling the borehole; monitoring the water activity of the formation and the water activity of the drilling fluid during the drilling; and adding additional formate or acetate to the drilling fluid as needed to maintain the water activity of the drilling fluid lower than or about equal to the water activity of the formation. Preferably, again, the formate or acetate is potassium formate. Most preferably, the oil-based fluid comprises an invert emulsion and the potassium formate is dissolved in the water phase of the emulsion. In yet another aspect, our invention comprises a method for drilling a borehole through a subterranean formation, the method comprising: preparing or obtaining an oil-based drilling fluid; determining the water activity of the drilling fluid and the water activity of the formation; adding sufficient formate or acetate to the drilling fluid such that the water activity of the drilling fluid is less than or about equal to the water activity of the formation; using the drilling fluid comprising the formate or acetate in drilling the borehole; monitoring the water activity of the formation and the water activity of the drilling fluid during the drilling; and adding additional formate or acetate to the drilling fluid as needed to maintain the water activity of the drilling fluid lower than or about equal to the water activity of the formation. Preferably the formate or acetate is potassium formate, and most preferably the oil-based fluid comprises an invert emulsion and the potassium formate is dissolved in the invert emulsion.

In our invention, using 1-12% potassium formate in an emulsion in which the aqueous phase is 5-25% by weight, the desired potassium formate level can be maintained by replenishing it as it is lost or absorbed by the subterranean formation throughout the drilling process, by correlating the potassium or potassium formate concentration to the water activity of the drilling fluid, without having to compare the water activity of the fluid to the water activity of the formation.

1. An emulsion useful in drilling wells comprising (a) a discontinuous aqueous phase comprising water and 1% to 12% by weight of said aqueous phase of potassium formate and (b) a continuous phase comprising oil, in a weight ratio of said oil to said aqueous phase of 95:5 to 75:25.

2. An emulsion of claim 1 including an emulsifier comprising a reaction product of a tall oil and a fatty alkanolamide.

3. An emulsion of claim 2 wherein said tall oil is distilled tall oil.

4. An emulsion of claim 2 wherein said tall oil includes 1% to 50% rosins.

5. An emulsion of claim 2 wherein said fatty alkanolamide is a coconut oil diethanolamide.

6. An emulsion of claim 2 wherein said emulsifier includes a reaction product of tall oil and aminoethylpiperazine.

7. An emulsion of claim 6 wherein said tall oil contains rosins in an amount up to 50%.

8. An emulsion of claim 6 wherein said tall oil is distilled tall oil.

9. An emulsion of claim 5 or 6 wherein said reaction product of tall oil and aminoethylpiperazine is further reacted with a reaction product of tall oil and a fatty alkanolamide.

10. An emulsion of claim 1 wherein said potassium formate comprises 3-8% of said aqueous phase.

11. A well drilling fluid comprising an emulsion of claim 1 and an oleophilic clay.

12. Method of drilling a well in a subterranean formation comprising drilling said well with a drilling fluid comprising a water-in-oil emulsion wherein said water includes about 1% to about 12% potassium formate.

13. Method of claim 12 wherein said emulsion is made using an emulsifier which is a reaction product of tall oil with a fatty alkanolamide.

14. Method of claim 12 including regulating the concentration of potassium formate in said drilling fluid throughout said drillling to maintain said concentration of potassium formate in said water within the range of 1% to 12%.

15. Method of claim 12 wherein the weight ratio of oil phase to water phase is in the range of 75:25 to 95:5 by weight.

16. Method of claim 15 wherein said concentration of potassium formate is regulated as a function of water activity.

17. Method of claim 12 wherein the ratio of oil phase to water phase is in the range of 75:25 to 85:15.

18. Method of claim 12 wherein the ratio of oil phase to water phase is in the range of 85:15 to 95:5.

19. Method of claim 12 wherein said emulsifier also includes a coconut oil diethanolamide.

20. Method of drilling a well through a subterranean formation which contains shale or clay comprising drilling said well in the presence of an emulsion wherein the continuous phase comprises oil and the discontinuous phase comprises a 1% to 12% solution of a potassium salt, said emulsion being circulated from said well to the surface and back to said well, intermittently monitoring the osmotic balance between said discontinuous phase and shale or clay cuttings circulating with said emulsion and maintaining the concentration of said potassium salt in said discontinuous phase within 1-12% by adding said potassium salt to maintain a desired osmotic balance thereof.

21. Method of claim 20 wherein said potassium salt is potassium formate.

22. Method of drilling a well through a subterranean formation which contains shale or clay comprising drilling said well in the presence of an emulsion wherein the continuous phase comprises oil and the discontinuous phase comprises a 1% to 12% solution of a potassium salt, said emulsion being circulated from said well to the surface and back to said well, intermittently monitoring the electrical stability of said emulsion and maintaining the concentration of emulsifier at a level to maintain a desired electrical stability.

23. Method of drilling a well through a subterranean formation which contains shale or clay comprising drilling said well in the presence of an emulsion wherein the continuous phase comprises oil and the discontinuous phase comprises a 1% to 12% solution of a potassium salt, said emulsion being circulated from said well to the surface and back to said well, intermittently monitoring the water activity of said emulsion and maintaining the concentration of potassium salt at a level to maintain a desired water activity.

24. Method of claim 23 wherein said potassium salt comprises potassium formate.

25. A method of stabilizing an invert emulsion for use in drilling a borehole in or through a subterranean formation, said method comprising:
preparing or obtaining an invert emulsion or an oil-based drilling fluid comprising an invert emulsion;
determining the water activity of the formation;
determining the water activity of the emulsion;
adding sufficient formate or acetate to said drilling fluid such that said water activity of said emulsion is less than or about equal to the water activity of said formation;
using said emulsion comprising said formate or acetate in drilling said borehole;
monitoring said water activity of said formation and said water activity of said emulsion during said drilling; and
adding additional formate or acetate to said emulsion as needed to maintain the water activity of said emulsion lower than or about equal to the water activity of said formation.

26. The method of claim 25 wherein said formate or acetate is potassium formate.

27. A method for drilling a borehole through a subterranean formation, said method comprising:
preparing or obtaining an oil-based drilling fluid;
determining the water activity of said drilling fluid and the water activity of said formation;
adding sufficient formate or acetate to said drilling fluid such that said water activity of said drilling fluid is less than or about equal to the water activity of said formation;
using said drilling fluid comprising said formate or acetate in drilling said borehole;
monitoring said water activity of said formation and said water activity of said drilling fluid during said drilling; and
adding additional formate or acetate to said drilling fluid as needed to maintain the water activity of said drilling fluid lower than or about equal to the water activity of said formation.

28. The method of claim 27 wherein said formate or acetate is potassium formate.

29. The method of claim 27 wherein said oil-based fluid comprises an invert emulsion and said potassium formate is dissolved in the water phase of said emulsion.
